(19) United States
(12) Patent Application Publication
(10) Pub. No.: US 2008/0065679 A1
(43) Pub. Date: Mar. 13, 2008

(54) METHOD FOR RULES-BASED DRAG AND DROP PROCESSING IN A NETWORK ENVIRONMENT

(76) Inventors: Douglas Ray Fish, Rochester, MN (US); John Edward Petri, Lewiston, MN (US)

Correspondence Address: Grant A. Johnson;IBM Corporation, Dept. 917, 3605 Highway 52 North, Rochester, MN, 55901-7829, US

(21) Appl. No.: 11/531,139

(22) Filed: Sep. 12, 2006

(51) Int. Cl. G06F 7/00

(52) U.S. Cl. 707/102

(57) ABSTRACT

A mechanism to efficiently classify and pre-process rules, encode and embed portions of the rules in the client page, and process them with minimal return trips to the server. One embodiment of the invention comprises a method for providing web applications, comprising generating a rules mapping for a web application view; and transmitting the web application view to a client device.

### FIELD OF THE INVENTION

The present invention generally relates to information management methods in a networked computer environment. More particularly, the present invention relates to an improved method for providing and maintaining rules-based graphical user interface functionality in a network environment.

### BACKGROUND

The development of the EDVAC computer system of 1948 is often cited as the beginning of the computer era. Although today's computer systems are more sophisticated than the EDVAC, the most basic requirements levied upon a computer have not changed. Now, as in the past, the job of a computer system is to access, manipulate, and store information. This fact is true regardless of its type or vintage.

Conventionally, computer programs/applications were installed and executed on each user's personal computing device. These so-called “fat-clients” were desirable before high-speed network connections became ubiquitous because most of the program's functionality could be delivered physically, via a floppy or compact disk. One problem with this model, however, is that installing and/or upgrading these applications typically required that someone perform a time-consuming, multi-step process on each computer. This, in turn, required that organizations employ large numbers of highly-trained technicians to perform these tasks. In practice, this drawback also led to substantial delays in software upgrades and deployment.

Web-based applications, or “web apps,” represent a partial solution to this problem. A web app generally refers to class of computer applications designed to be delivered to users over a network, typically the Internet. In this model, powerful server computers generate a series of web pages in a standard format, such as HTML. Web browser applications, such as the Firefox browser from the Mozilla Organization and the Internet Explorer browser from Microsoft Corporation, interpret and display these web pages, thereby acting as a universal client.

This network-centric model has become increasingly popular because it allows administrators to update and maintain most applications without having to distribute and install patches on each of client device in their organization. Despite this advantage, however, fat-clients continue to be used because they can provide a richer graphical user interface. That is, due to the inherent lag in a network environment and the slow transmission speeds of many legacy networks, it can be very difficult to duplicate the features and the responsiveness of the traditional fat client.

Asynchronous JavaScript And XML (“AJAX”) is one partial solution to this problem. AJAX generally refers to a loose collection of technologies and web development techniques that shift functionality from the web server to the client computers, which then exchange data with the servers behind-the-scenes in a way that mimics the interface provided by locally running, fat-client programs.

While AJAX technology represents a significant advance, existing techniques are unable to evaluate complex rules sets with sufficient speed to fully duplicate a fat-client-like user experience. For example, while an AJAX email application may contain rules that allow the web browser to evaluate whether a particular folder is a valid target in response to a drag-and-drop action, the current art lacks the practical ability to highlight which folders are valid targets while the end user is performing that drag-and-drop operation.

This limitation has prevented the spread of AJAX techniques into complex environments, such as such as an Electronic Common Technical Document (eCTD) used for Food and Drug Administration submissions. That is, user expectations and/or statutes require that complex web applications provide a wide range of GUI functionality, such as the ability to share documents, check documents in/out, and control access to individual documents. The existing AJAX techniques fail to satisfy the requirements of this domain because they can either only provide post failure messages (which is not a good user experience) or communicate with the server for each drop target (which is very slow).

Thus, without a way to provide an efficient processing mechanism to efficiently classify and pre-process rules, encode and embed portions of the rules in the client page, and process rules with minimal return trips to the server, the promise of web applications may never be fully achieved.

### SUMMARY

The present invention provides an efficient processing mechanism to classify and pre-process rules, encode and embed portions of the rules in the client page, and process rules with minimal return trips to the server. One embodiment of the invention comprises a method for providing web applications, comprising generating a rules mapping for a web application view; and transmitting the web application view to a client device. In some embodiments, the rules mapping is a binary array comprising matched groups of rule identifiers and evaluation attributes. This binary array may be encoded in a web page representing the web application view.

Another embodiment of the invention is a computer program product, comprising a program configured to perform a method for providing web applications and a computer readable media bearing the program. The method for providing web applications in this embodiment comprises generating a rules mapping for a page view and transmitting the page view to a client device.

Another embodiment of the invention is a server computer for web applications comprising a GUI server that generates a rules mapping for a web application and a web server that encodes the rules array into a first document for the web application.

### BRIEF DESCRIPTION OF THE DRAWINGS

FIG. 1 illustrates one embodiment of a web application system.

FIGS. 2A-2B illustrate a compound document inside an exemplary complex web application.

FIG. 3A-3C illustrate the operation of the web application system in more detail.

FIG. 4 illustrates the web application system, in operation, responding to a drag-and-drop interaction.

FIG. 5 illustrates the web application environment, in operation, responding to complex GUI interactions.

FIG. 6 illustrates a computer system suitable for use as a server computers or client device.

### DETAILED DESCRIPTION

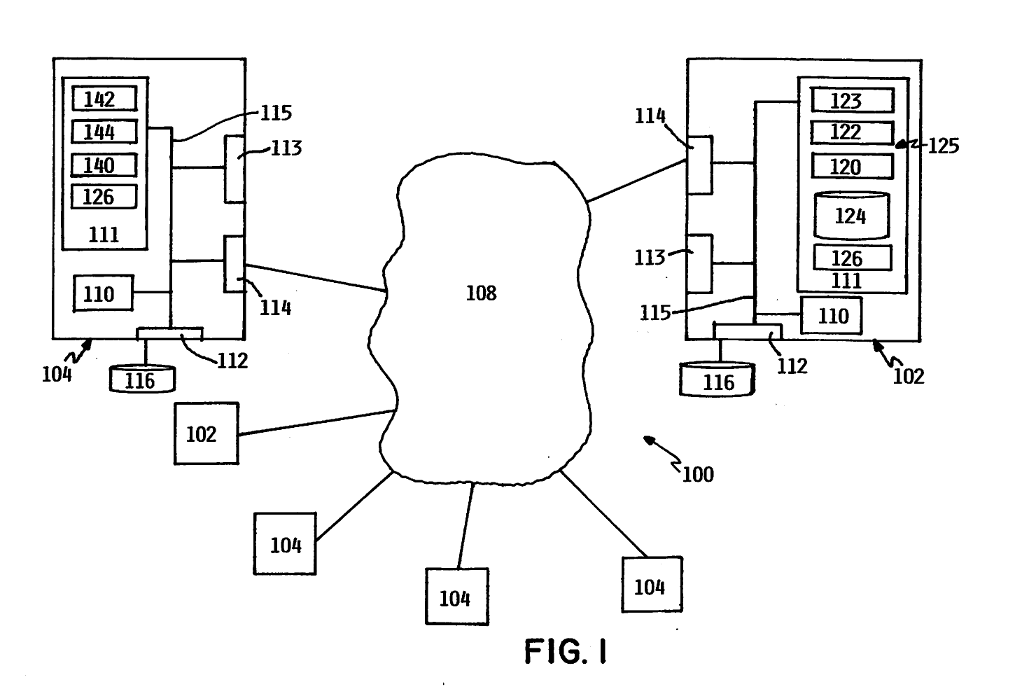

FIG. 1 illustrates one embodiment of a web application system 100. This system 100 includes a plurality of server computers 102, each executing a web server/AJAX host program 120 and a business application program 122 (referred collectively hereafter as the UI server 125) that cooperate to respond to information requests from a plurality of client devices 104. The client devices 104, in turn, receive requests from an end user via a client UI application 140, such a web browser, and transmit those requests to the UI server 125 using an asynchronous communication medium 108, such as AJAX, IFRAME, and/or Java applets transmitted over the Internet.

FIG. 1 also shows one of the servers 102 and one of the clients 104 in greater detail. Each device 102, 104 in this embodiment comprises a processor 110 connected to a main memory 111, a mass storage interface 112, an input/output (“I/O”) interface 113, and a network interface 114 via a system bus 115. The mass storage interface 112 connects one or more mass storage devices 116, such as a hard disk drive or CD-ROM drive, to the system bus 115. The I/O interface 113 connects one or more input/output devices (not shown), such as a keyboard or LCD display, to the system bus 115. The network interface 114 allows each computing device 102, 104 to communicate with the other computing devices 102, 104 over the communications medium 108. The memory 111 in the server computer 102 contains one or more computer programs, including the AJAX server 120, the business application program 122, an operating system 123, a database 124, and a server-side copy of one or more binary arrays 126. The memory 111 in the client device 104 similarly contains one or more computer programs, including the UI client 140, an operating system 142, a Java runtime environment 144, and a client-side copy of the one or more binary arrays 126.

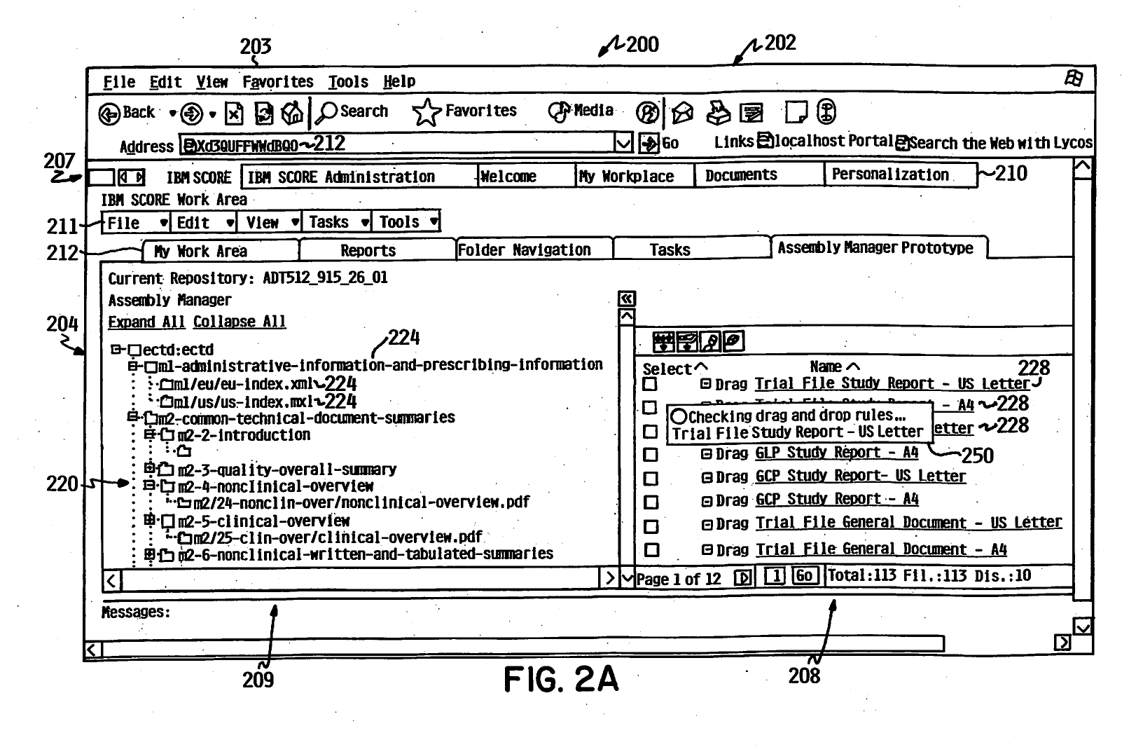

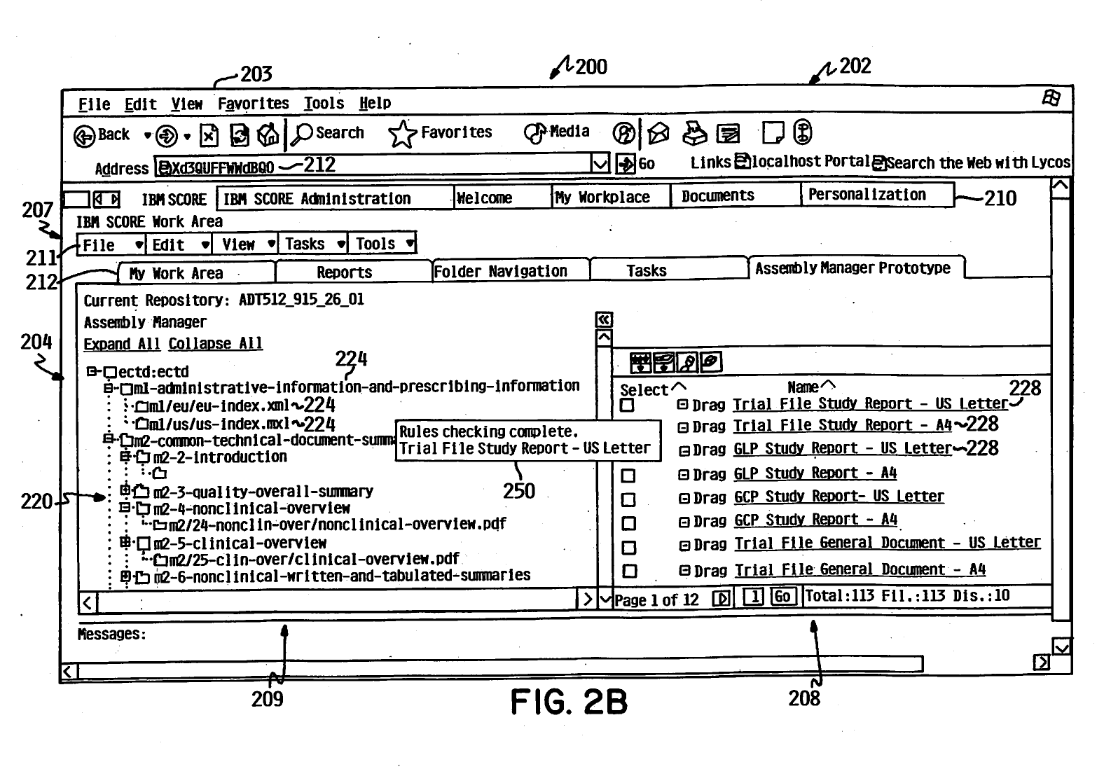

FIGS. 2A-2B collectively illustrate a compound document 202 inside an exemplary complex web application 200. This exemplary compound document 202 is generated by the UI server 125 and displayed in a browser window 203 by the UI client 140. The compound document 202 in this web application 201 comprises a main display area 204 and a control bar 207. The main display area 204, in turn, comprises a work panel 208 and a management panel 209. The control bar 207 comprises a plurality of application tabs 210, a management toolbar 211, and a plurality of document tabs 212.

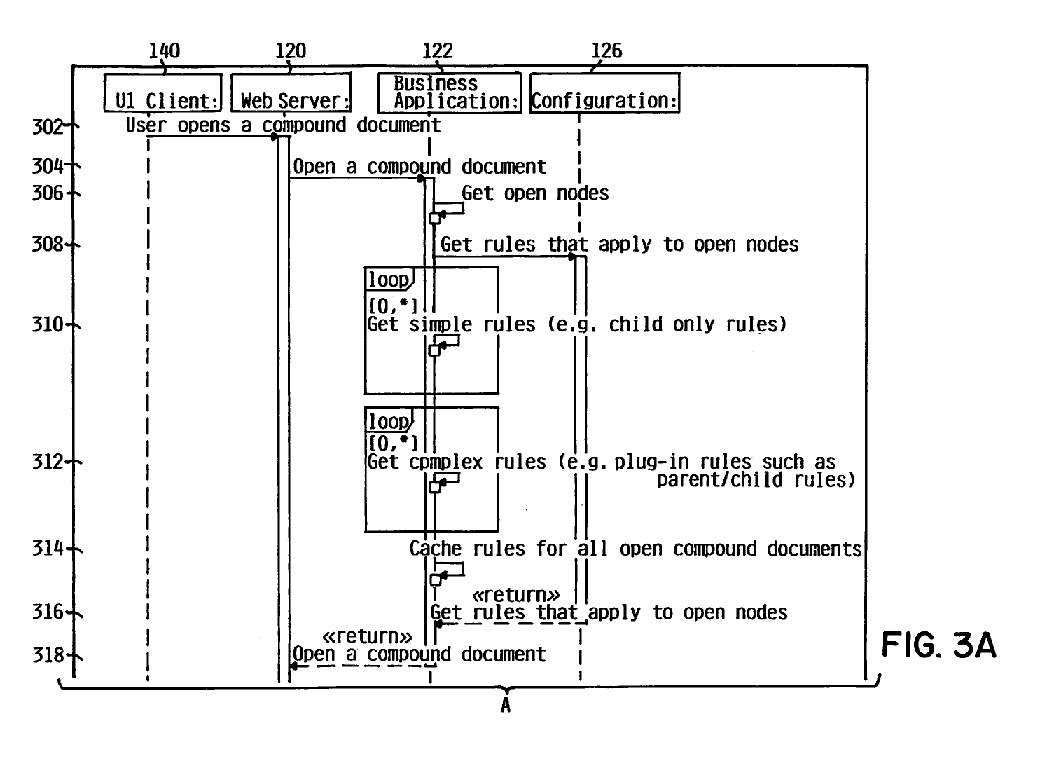

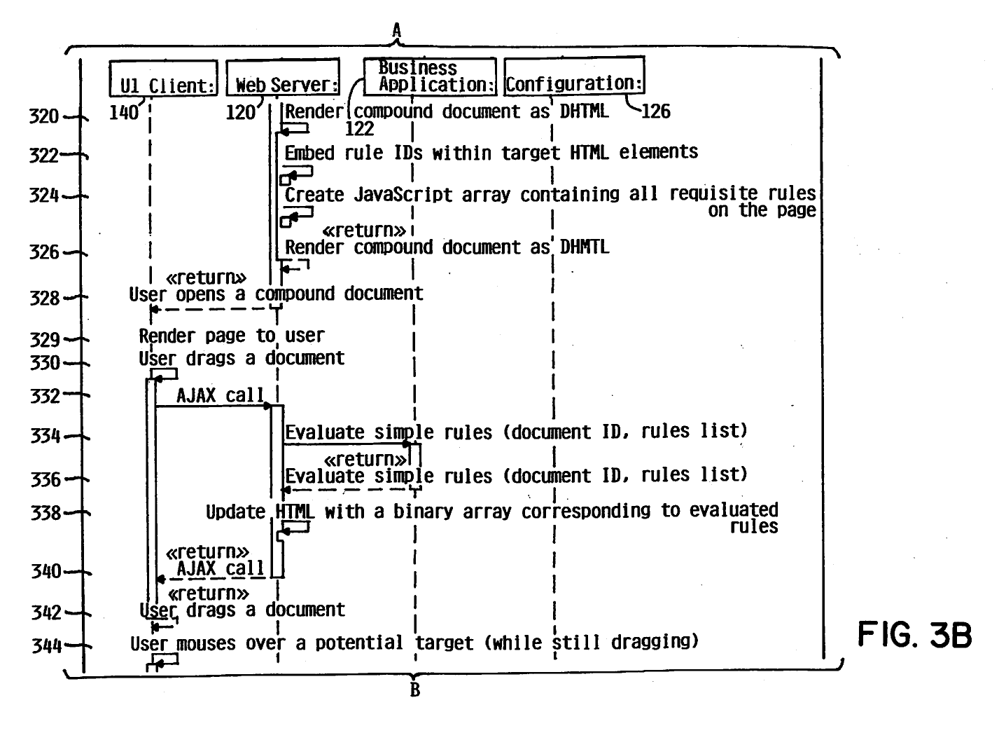

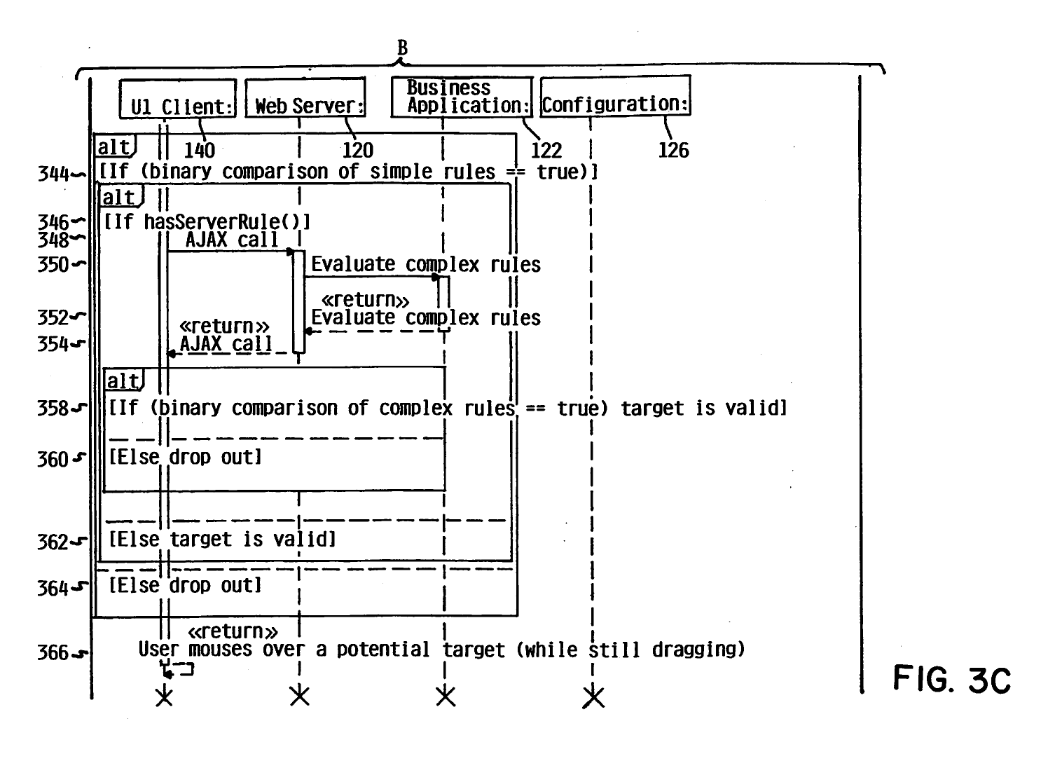

With continuing reference to FIGS. 2A-2B, the work panel 208 in this compound document 202 contains a plurality of manipulable objects 228 (only some labeled for clarity) containing representing various portions of the overall web application 200 that can be manipulated by the user. The management panel 209 contains a document tree 220 comprising a plurality of nodes 224 (only some labeled for clarity), each of which represents a section inside the compound document 202 and serves as potential drop targets for the objects 228 in the work panel 208. FIG. 2A depicts the document 202 as it is being run through the XML rules processor described in more detail with reference to FIGS. 3-5. FIG. 2B depicts the document 202 after it has been run through the XML rules processor. This means that at least some of the nodes 224 in FIG. 2B were defined in the binary array(s) 126 as having rules against them, and therefore, are marked up with special attributes and processing instructions so they can be identified for the user by the UI client 140.

In operation, the UI server 125 in this embodiment encodes information and rules about GUI functionality into the binary array(s) 126. The UI server 125 embeds the binary array(s) 126 into the source code for the compound document 202 so that, when the document 202 is rendered at the UI client 140, the UI client 140 can efficiently perform checks without having to make frequent requests to the UI server 125 for additional information. More specifically, upon receiving the initial request for a compound document 202, the AJAX server program 120 in this embodiment first communicates with the business application program 122 via an application programming interface to determine which rules are applicable for the nodes 224 in that document 202. After determining which rules are applicable, the AJAX server 120 encodes this information into the binary array(s) 126 and embeds these array(s) 126 into the markup language code for the requested compound document 202. These binary array(s) 126, in turn, contain one or more rule identifiers and an evaluation attribute for each node 224 that is a potential interface target in the compound document 202. In this way, the array(s) 126 contain all of the input that the UI client 140 will need to evaluate whether a particular GUI action is valid. In some embodiments, the present invention may also cache the rule identifiers for certain Java bean-backed elements (e.g., folder elements in a tree) on the UI server 125 to further improve efficiency.

When an end user begins to drag an object 228, the UI client 140 first communicates with the server UI 125 via AJAX to evaluate the self-contained rules for the document (i.e., relatively simple rules that pertain only to the document being dragged, such as whether a document is flagged “steady_state”). The UI server 125 passes the document ID and all applicable rules for the page to an application layer API at the server 125. The application 122 then evaluates the self-contained rules and then returns to the UI server 125 a binary array indicating which rules that the document has met (‘1’) and failed to meet (‘0’). At this point, the UI server 125 sends the binary array 126 back to the UI client 140, which inspects these values and subsequently “turns off” the target elements 224 whose rules have not been met. In this way, when the binary arrays come back from the application layer, the comparisons that occur on the client are very fast and can eliminate many trips to the server for more complete rules checking.

In addition to these checks, the UI client 140 also receives from the UI server 125 when requesting rules, information about whether or not a rule requires further server validation. For those target elements 224 that are still valid after the initial processing, the UI client 140 may also determine if they require additional server-side validation using a flag set in the element's underlying markup code. This flag indicates that bit-checking the rules at runtime succeeded, but that the client UI still needs to go back to the server to evaluate the more complex rules.

Thus, in the example web application 201 shown in FIGS. 2A-2B, when the user starts to drag a document, the UI client 140 goes back to the server asynchronously (via hidden IFRAME or the like) to evaluate the current document against all the rules on the page. As the user starts to drag, the user sees a pop up 250 that follows their mouse cursor. This pop up 250 displays the rules processing status, as well as other information, such as the identity of the object 228, the identity of the web application 200, the identity of the user, the security level of the user, and the like.

FIGS. 3A-3C illustrate the operation of the web application system 100 in more detail. In these figures, the vertical axis represents time and the horizontal axis represents interactions between the major components of the system 100. The user begins work by instructing the UI client 140 to open a compound document 202 of a web application 200. The UI client 140 receives this instruction and forwards the instruction to the UI server 125 at line 302. In response, the AJAX server program 120 parses the instruction from the UI client 140 to determine what business application program 122 to which the request is relevant, and then passes the request to that business application program 122 at line 304.

The business application program 122 begins processing the user's request by generating a list of open nodes 224 in the requested document 202. Next, at lines 308-312, the business application program 122 generates a list of rules that apply to those open nodes 224. This may include generating simple rules (e.g., child only rules) at line 310, generating complex rules (e.g., plug-in rules, such as parent child rules) at line 312, or some combination of simple and complex rules. At lines 316-318, the business application program 122 returns the generated rules to the AJAX server 120. In some embodiments, the business application program 122 may further cache the generated rules for future use at line 314.

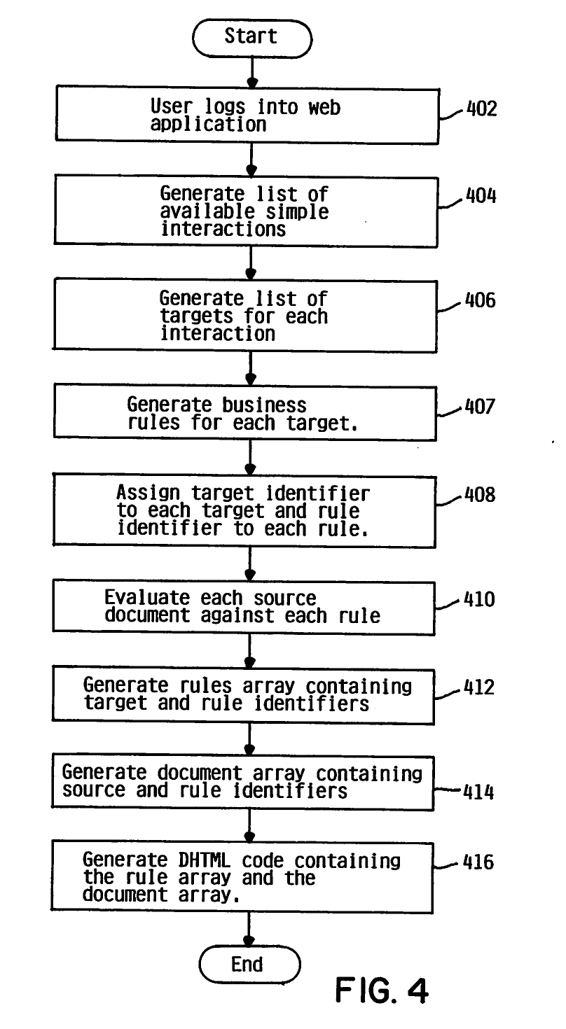

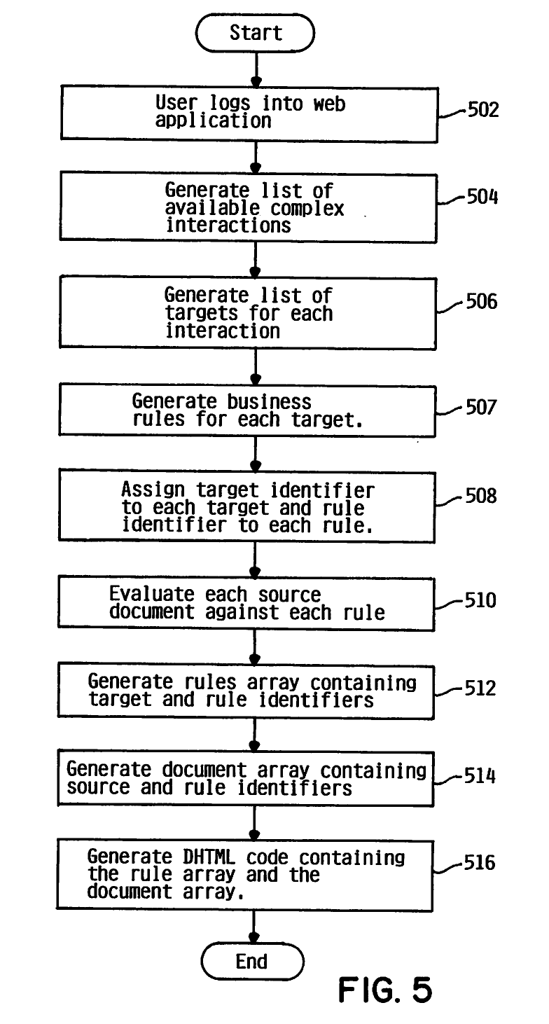

At lines 320-322, the AJAX server 120 generates a dynamic HTML (“DHTML”) web page responsive to the user's request. This process includes rendering the compound document 202 at line 320, embedding rule identifiers for the target objects 224 in the page 202 at line 322, and creating a binary array 126 containing the returned rules and corresponding rule ID's (described in more detail with reference to FIGS. 4-5). The UI server 125 then transmits the compound document 202, including the embedded binary array 126, to the client device 104 at lines 326-328.

After receiving the generated web page 202 at line 328, the UI client 140 renders the compound document 202 for the user at line 329. The UI client 140 then waits for the user to interact with the web application 200. In response to a simple GUI interaction, such as the user dragging an object to a folder, the UI client 140 makes an AJAX call to the UI server 125 at line 332. That is, the UI client 140 transmits a request to the UI server 125 requesting the identity (“ID”) of the source document (i.e., the one being dragged). In response, the business application 122 evaluates the simple rules with respect to the document ID to determine which rules the document meets and which it does not meet. The web server 120 then generates a new binary array 126 at line 338 containing the results of this rule evaluation and embeds this information in a new DHTML page and binary array 126 at line 336. The UI server 125 then returns the DHTML page and binary array 126 to the UI client 140 at lines 340-342.

The UI client 140 then evaluates the new binary array 126 at lines 342-364. More specifically, the UI client 140 parses the document 202 to get the rule identifier for each potential drop target(s) 224 at line 342. Note that the rule identifier array for each drop target was created when the page was generated, and it describes which rules the drop target requires for a source to be “valid.” The UI client 140 then uses the rule IDs at line 344 to find each element in binary array 126 that corresponds to those element(s) each rule identifier in the array for that drop target. If the binary array 126 contains only a binary-true for each rule in the array for node 224 (e.g., only simple rules), the UI client indicates that the drop target is valid at line 362; otherwise, the UI client determines whether the drop target has an associated server rule at line 346.

If the UI client determines that the drop target has an associated server rule, the UI client generates a request to evaluate the rule. The server 120 receives this request at line 346 and then forwards the request to the appropriate business application 122 at line 348. The business application 122 evaluates the complex server rule and then passes the results back to the web server 120 and UI client 140 at lines 352-354. If the complex rule evaluated true for the target, the UI client 140 indicates that the drop target is valid at line 358.

If the binary array contained a binary-false value for any rule associated with the target (at line 344) or the complex rule evaluated as false (at line 358), the UI client 140 indicates that the node 224 is not a valid drop target at line 364. The UI client 140 then indicates the results of this analysis to the user at line 366.

FIG. 4 illustrates the web application system 100, in operation, responding to a drag-and-drop interaction. At block 402, the end user logs into the web application 200. In response, the UI server 125 first determines which GUI interactions are available in the web application 200 at block 404. For each permitted operation, the UI server 125 then generates a list of potential targets at block 406. Next, at block 407, the UI server 125 interrogates each target to generate a list of associated business rules at block 407. At block 408, the UI server assigns a target identifier to each target 224 and a rule identifier to each rule. At block 410, the UI server 125 assigns each source document a Document ID, and then evaluates each source document against each rule. The UI server 125 uses this information to generate a the document array 126 at block 412 that indicates what rules are required for each target in the document 202 and a binary rules array 126 at block 414 that indicates which rules a particular source satisfies. At block 416, the UI server 125 embeds both arrays into DHTML code for the web application 200. In this way, the UI server 125 evaluates each rule for each document returned from the query and then creates an array within the page that indicates which of the rules the document meets, all before sending the rendered page to the UI client 140. The UI client 140 can then use JavaScript code or the like to quickly evaluate from the arrays whether a particular action is allowed.

For purposes of illustration, assume a simple web application 200 is comprised of a single compound document 202 that contains one permitted GUI interaction, drag and drop and one potential drop target 224, a folder called “target_folder”. The target_folder element 224, in turn, is associated with one rule requiring that: “source documents must be in ‘steady_state’ to be placed in this folder.” In this example, the binary rules array 126 would contain the following information:

| Target ID | Rule ID |
|---|---|
| 0 | 0 |

and the binary document array 126 would contain the following information:

| Document ID | Rule met |
|---|---|
| 0 | 1 |

Thus, in this example, when the user drags a document to the “target_folder” element, the UI client 140 first checks the document array to see if there is a “1” in the array index corresponding to the rule ID. If the value is “1” the drop is allowed, otherwise it is not.

FIG. 5 illustrates the web application environment 200, in operation responding to complex GUI interactions. At block 502, the end user logs into the web application 200. In response, the UI server 125 first determines what complex GUI interactions are available in the web application 200 at block 504. For each permitted complex operation, the UI server 125 then generates a list of potential targets 224 at block 506. Next, at block 507, the UI server 125 interrogates each potential target to generate a list of business rules that are present in that document. At block 508, the UI server assigns a target identifier to each target 224 and a rule identifier to each rule. At block 510, the UI server 125 assigns each source document a Document ID, and then evaluates each source document against each rule. The UI server 125 uses this information to generate a binary document array 126 at block 512 that indicates what rules are required for each target in the document 202 and a binary rules array 126 at block 514 that indicates which rule(s) a particular source satisfies. At block 516, the UI server 125 embeds both arrays into DHTML code for the web application 200.

For purposes of illustration, assume an example complex web application 200 has two different types of documents (“program_document” and “standard_procedure”), and three potential drop targets (“target_folder1,” “target_folder2,” and “target_folder3”). Each target 224 has a business rule that requires “source documents must be in ‘steady_state’ to be placed in this folder.” “Target_folder2” and “target_folder3” have an additional rule that requires “source documents must be of type ‘standard_procedure’ to be placed in this folder.” “Target_folder3” has still another rule that requires “the source document's ‘project’ attribute must be equal to its parent's ‘project’ attribute.” In this simplified example, the HTML code for the drop targets would look as follows:

| | |
|---|---|
| target_folder1 | <div ruleIDs=“0”> |
| target_folder2 | <div ruleIDs=“0, 1”> |
| target_folder3 | <div ruleIDs=“0, 1, 2” serverRuleIDs=“2”>. |

The serverRuleIDs attribute in this example indicates that additional server-side checking is required for the complex rule. The rules array 126 would contain the following information:

| Array index | Rule ID |
|---|---|
| 0 | 0 |
| 1 | 1 |
| 2 | 2 |

a document of type “program_document” would contain the following information:

| Array index | Rule met |
|---|---|
| 0 | 1 |
| 1 | 0 |

and a document of type “standard_procedure” would contain the following information:

| Array index | Rule met |
|---|---|
| 0 | 1 |
| 1 | 1 |

In this example, if the user drags a program_document to the “target_folder1” element, the UI client 140 checks the document array to see if there is a “1” in the array index corresponding to the rule ID. Because the value is “1,” the drop is allowed. Similarly, if a user drags a “standard_procedure” document to “target_folder2,” two indices will checked before a drop is allowed. Because the value of both is “1,” the drop is allowed. If a user drags a “program_document” to “target_folder3” (which contains a complex rule), when rule 0 and 1 are met a drop is still not allowed until further checking is done on the server 125. The UI client 140 facilitates this by communicating with the UI server in the background to evaluate rule 2. If all rules are met, then the drop is allowed.

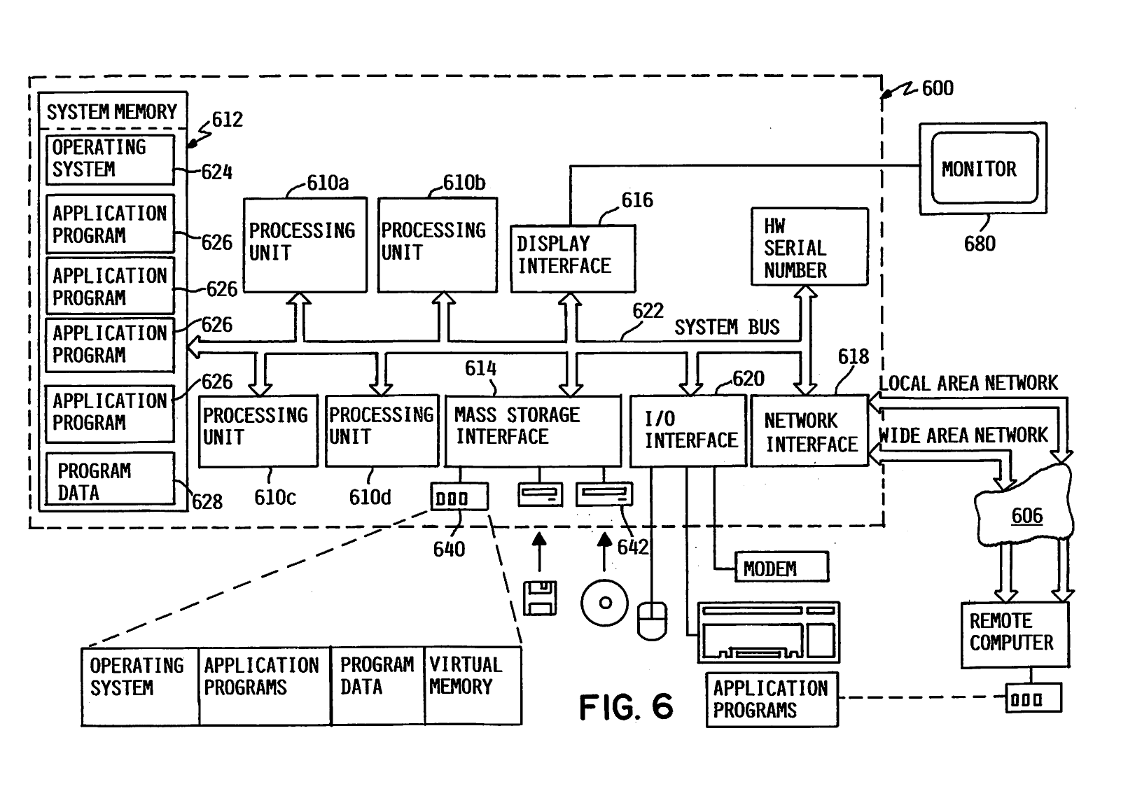

FIG. 6 illustrates a computer system 600 suitable for use as the server computers 102 and the client devices 104. It should be understood that this figure is only intended to depict the representative major components of the computer system 600 and that individual components may have greater or lesser complexity that represented in FIG. 6. Moreover, components other than or in addition to those shown in FIG. 6 may be present, and that the number, type, and configuration of such components may vary. Several particular examples of such additional complexity or additional variations are disclosed herein; it being understood that these are by way of example only and are not necessarily the only such variations.

This computing system 600 embodiment comprises a plurality of central processing units 610a-610d (herein generically referred to as a processor 610 or a CPU 610) connected to a main memory unit 612, a mass storage interface 614, a terminal/display interface 616, a network interface 618, and an input/output (“I/O”) interface 620 by a system bus 622. The mass storage interfaces 614, in turn, connect the system bus 622 to one or more mass storage devices, such as a direct access storage device 640 or a readable/writable optical disk drive 642. The network interfaces 618 allow the computer system 600 to communicate with other computing systems 600 over the communications medium 606. The main memory unit 612 in this embodiment also comprises an operating system 624, a plurality of application programs 626 (such as the AJAX server 120 and the business application program 122), and some program data 628.

The computing system 600 in this embodiment is a general-purpose computing device. Accordingly, the CPU's 610 may be any device capable of executing program instructions stored in the main memory 612 and may themselves be constructed from one or more microprocessors and/or integrated circuits. In this embodiment, the computing system 600 contains multiple processors and/or processing cores, as is typical of larger, more capable computer systems; however, in other embodiments, the computing system 600 may comprise a single processor system and/or a single processor designed to emulate a multiprocessor system.

When the computing system 600 starts up, the associated processor(s) 610 initially execute the program instructions that make up the operating system 624, which manages the physical and logical resources of the computer system 600. These resources include the main memory 612, the mass storage interface 614, the terminal/display interface 616, the network interface 618, and the system bus 622. As with the processor(s) 610, some computer system 600 embodiments may utilize multiple system interfaces 614, 616, 618, 620, and buses 622, which in turn, may each include their own separate, fully programmed microprocessors.

The system bus 622 may be any device that facilitates communication between and among the processors 610; the main memory 612; and the interfaces 614, 616, 618, 620. Moreover, although the system bus 622 in this embodiment is a relatively simple, single bus structure that provides a direct communication path among the system bus 622, other bus structures are within the scope of the present invention, including without limitation, point-to-point links in hierarchical, star or web configurations, multiple hierarchical buses, parallel and redundant paths, etc.

The main memory 612 and the mass storage devices 640 work cooperatively to store the operating system 624, the application programs 626, and the program data 628. In this embodiment, the main memory 612 is a random-access semiconductor device capable of storing data and programs. Although FIG. 6 conceptually depicts this device as a single monolithic entity, the main memory 612 in some embodiments may be a more complex arrangement, such as a hierarchy of caches and other memory devices. For example, the main memory 612 may exist in multiple levels of caches, and these caches may be further divided by function, so that one cache holds instructions while another holds non-instruction data to be used by the processor(s) 610. The memory 612 may also be further distributed and associated with different CPUs 610 or sets of CPUs 610, as is known in any of various so-called non-uniform memory access (NUMA) computer architectures. Moreover, some embodiments may utilize virtual addressing mechanisms that allow the computing systems 600 to behave as if it has access to a large, single storage entity instead of access to multiple, smaller storage entities, such as the main memory 612 and the mass storage device 640.

Although the operating system 624, the application programs 626, and the program data 628 are illustrated as being contained within the main memory 612, some or all of them may be physically located on different computer systems and may be accessed remotely (e.g., via the communication media 108) in some embodiments. Thus, while the operating system 624, the application programs 626, and the program data 628 are illustrated as being contained within the main memory 612, these elements are not necessarily all completely contained in the same physical device 600 at the same time, and may even reside in the virtual memory of other computer systems 600.

The system interface units 614, 616, 618, 620 support communication with a variety of storage and I/O devices. The mass storage interface unit 614 supports the attachment of one or more mass storage devices 640, which are typically rotating magnetic disk drive storage devices, although they could alternatively be other devices, including arrays of disk drives configured to appear as a single large storage device to a host and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, high definition disks, IBM Millipede devices, and the like.

The terminal/display interface 616 is used to directly connect one or more display units 680 to the computer system 600. These display units 680 may be non intelligent (i.e., dumb) terminals, such as a cathode ray tube, or may themselves be fully programmable workstations used to allow IT administrators and users to communicate with the computing system 600. Note, however, that while the interface 616 is provided to support communication with one or more displays 680, the computer systems 600 does not necessarily require a display 680 because all needed interaction with users and other processes may occur via network interface 618.

The computing system 600 in FIG. 6 is depicted with multiple attached terminals 680, such as might be typical of a multi-user “mainframe” computer system. In such a case, the actual number of attached devices is typically greater than those shown in FIG. 6, although the present invention is not limited to systems of any particular size. The computing systems 600 may alternatively be a single-user system, typically containing only a single user display and keyboard input, or might be a server or similar device which has little or no direct user interface, but receives requests from other computer systems (clients). In other embodiments, the computing systems 600 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

One exemplary computing system 600, particularly suitable for use as the web server 102, is the System i platform running the i5/OS multitasking operating system and the Websphere web application server program, all of which are produced by International Business Machines Corporation of Armonk, N.Y. Another exemplary computing system 600, particularly suitable use as the client device 104, is a personal computer running one of the Linux or Windows operating systems. However, those skilled in the art will appreciate that the methods, systems, and apparatuses of the present invention apply equally to any computing system 600 and operating system combination, regardless of whether one or both of the computer systems 600 are complicated multi user computing apparatuses, a single workstations, lap-top computers, mobile telephones, personal digital assistants (“PDAs”), video game systems, or the like.

Referring again to FIGS. 1 and 2, the web browser program 180 may be any device that allows for viewing the content of the Internet. In this embodiment, the web browser 180 is a program that is capable of parsing and presenting documents written in the standard Internet mark language protocols, such as HTML, dynamic HTML, and XML. Upon starting the web browser 180, the first page the user sees is the current “home page”. The URL of the home page can be regarded as the first bookmark in the browser 180 and is often a portal into the web application 200. Although entry of a URL is one way of interacting with the web application 200, the user may also traverse to another documents and views 202 by clicking highlighted words, images or graphics in a page activating an associated hyperlink to bring another page or related information to the screen. Each hyperlink contains encoded URL location information that serves as an address to the next document or view in the web application 200. Navigational aids, such as the “Back” and “Forward” toolbar buttons are also available to proceed back or forward to pages 202 which have been previously accessed. Suitable browsers 180 include the Mozilla Firefox browser and the Microsoft Internet Explorer browser. However, many other browsers 180 are within the scope of the present invention, some of which are general purpose and have many capabilities to provide a variety of functions, while others are designed for special purpose use.

The URL or “Uniform Resource Locater” may be any code or set of parameters capable of locating resources on the network. The current definition for the Internet network is defined in RFC 1945, which is incorporated herein by reference. Under this specification, the URL is typically of the format: http://somehost/somedirectory?parameters . . . “where “somehost” is the hostname position of the URL, “somedirectory” is a directory in which the web page may be found. The usual manner in which a URL is resolved into an actual IP address for a web server is through the use of a nameserver. In an Internet or intranet network, a nameserver maps hostnames in URLs to actual network addresses. An example of a nameserver is the Domain Name Service (DNS) currently implemented in the Internet. The process of having a Web client request a hostname and address from a nameserver is sometimes called resolution. In TCP/IP, the nameserver resolves the hostname into a list of one or more IP addresses which are returned to the Web client in an HTTP request. Each IP address identifies a server which hosts the requested content made by the browser.

The communication media 108 may be any suitable network or combination of networks and may support any appropriate protocol suitable for communication of data and/or code to/from multiple computing systems 600. Accordingly, the network interfaces 618 can be any device that facilitates such communication, regardless of whether the network connection is made using present day analog and/or digital techniques or via some networking mechanism of the future. Suitable communication media 108 include, but are not limited to, networks implemented using one or more of the IEEE (Institute of Electrical and Electronics Engineers) 802.3x “Ethernet” specification; cellular transmission networks; and wireless networks implemented one of the IEEE 802.11x, IEEE 802.16, General Packet Radio Service (“GPRS”), FRS (Family Radio Service), or Bluetooth specifications. Those skilled in the art will appreciate that many different network and transport protocols can be used to implement the communication medium 108. The Transmission Control Protocol/Internet Protocol (“TCP/IP”) suite contains suitable network and transport protocols.

The embodiments in FIGS. 1-6 utilize a client-server network architecture. These embodiments are desirable because the clients 104 can utilize the web servers 102 without either system 102, 104 requiring knowledge of the working details about the other. However, those skilled in the art will appreciate that other network architectures are within the scope of the present invention. Examples of other suitable network architectures include peer-to-peer architectures, grid architectures, and multi-tier architectures. Accordingly, the terms web server and client computer should not be construed to limit the invention to client-server network architectures.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of tangible, computer-readable signal bearing medium used to actually carry out the distribution. Examples of suitable tangible, computer-readable signal bearing media include, but are not limited to: (i) non-writable storage media (e.g., read only memory devices (“ROM”), CD-ROM disks readable by a CD drive, and Digital Versatile Disks (“DVDs”) readable by a DVD drive); (ii) writable storage media (e.g., floppy disks readable by a diskette drive, CD-R and CD-RW disks readable by a CD drive, random access memory (“RAM”), and hard disk drives); and (iii) communications media (e.g., computer networks, such as those implemented using “Infiniband” or IEEE 802.3x “Ethernet” specifications; telephone networks, including cellular transmission networks; and wireless networks, such as those implemented using the IEEE 802.11x, IEEE 802.16, General Packet Radio Service (“GPRS”), Family Radio Service (“FRS”), and Bluetooth specifications). Those skilled in the art will appreciate that these embodiments specifically include computer software down-loaded over the Internet.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. This service engagement may be directed at providing both the server-side operations and the client-side operations, may be limited to only server-side operations, or some combination thereof. Accordingly, these embodiments may further comprise receiving charges from other entities and associating that charge with specific users of the servers 102 and/or clients 104.

The various software components illustrated in FIGS. 1-6 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system, and that, when read and executed by one or more processors in the computer system, cause the computer system to perform the steps necessary to execute steps or elements comprising the various aspects of an embodiment of the invention. The various software components may also be located on different systems 102, 104 than depicted in FIGS. 1-6. Thus, for example, the UI server 125 and the UI client 104 could be executing on the same computing device and the communication channel 108 could comprise messages between applications on that device.

Those skilled in the art will appreciate that accompanying figures and this description depicted and described embodiments of the present invention, and features and components thereof. Any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

We claim:

1. A method for providing web applications, comprising:
generating a rules mapping for a web application view; and
transmitting the web application view to a client device.

2. The method of claim 1, wherein the rules mapping comprises a binary array.

3. The method of claim 2, wherein the binary array comprises matched groups of rule identifiers and evaluation attributes.

4. The method of claim 3, further comprising encoding the binary array in web page, the web page representing the web application view.

5. The method of claim 1, wherein the rules mapping encodes a plurality of graphical user interface operations.

6. The method of claim 5, wherein the web application view comprises a compound document inside web application.

7. The method of claim 6, wherein the compound document comprises a plurality of manipulatable objects and a plurality of nodes.

8. The method of claim 7, further comprising associating an additional processing indicator at least one of the plurality of nodes.

9. The method of claim 1, further comprising:
receiving a source identifier from the client device;
evaluating at least one simple rule associated with the source identifier;
generating an updated rules mapping; and
transmitting the updated rules mapping to the client device.

10. The method of claim 9, wherein the rules mapping further comprises a server rule identifier;

11. The method of claim 9, further comprising receiving server rule evaluation request; and evaluating the requested server rule.

12. The method of claim 1, further comprising generating a DHTML web page containing the rules mapping.

13. A method for deploying computing infrastructure, comprising integrating computer readable code into a computing system, wherein the code in combination with the computing system is adapted to perform the method of claim 1.

14. The method of claim 13, further comprising:
metering use of the computing infrastructure; and
allocating expenses to users of the computing infrastructure.

15. A computer program product, comprising:
(a) a program configured to perform a method for providing web applications, comprising:
generating a rules mapping for a page view; and
transmitting the page view to a client device.
(b) a computer readable media bearing the program.

16. The computer program product of claim 15, wherein the computer readable media comprises the internet.

17. A server computer for web applications, the server computer having a network interface adapted to provide access to a network, the server computer comprising:
GUI server that generates a rules mapping for a web application; and
a web server that encodes the rules array into a first document for the web application.

18. The server of computer claim 17, further comprising a business application that generates matched groups of rule identifiers and evaluation attributes.

19. The server computer of claim 17, wherein the rules mapping comprises a binary rules array and wherein the first document comprises a web page.

20. The server computer of claim 17, wherein the rules mapping encodes graphical user interface functions.
